(19) United States
(12) Patent Application Publication
(10) Pub. No.: US 2003/0075413 A1
(43) Pub. Date: Apr. 24, 2003

(54) Hydraulically operated double clutch

(76) Inventor: Sverker Alfredsson, Vastra Frolunda (SE)

Correspondence Address: YOUNG & THOMPSON, 745 SOUTH 23RD STREET 2ND FLOOR, ARLINGTON, VA, 22202

(21) Appl. No.: 10/149,764

(22) PCT Filed: Dec. 11, 2000
(86) PCT No.: PCT/SE00/02482

(30) Foreign Application Priority Data
Dec. 13, 1999 (SE) 9904550-2

(51) Int. Cl. F16D 25/10

(52) U.S. Cl. 192/87.15; 192/48.91; 192/106 F

(57) ABSTRACT

Hydraulically operated double clutch with first and second piston-cylinder devices for engagement and disengagement of the respective clutch unit. The cylinder chamber (17) of the first piston-cylinder device is delimited between its piston (18) and a first wall (4) of the clutch housing (1), while the cylinder chamber (24) of the second piston-cylinder device is delimited between its piston (25) and the first mentioned piston (18). A third cylinder chamber (30) is delimited between the piston (25) of the second piston-cylinder device and a second wall (6) of the clutch housing (1). Channels (31-34) are arranged for supply of pressure medium to and from the cylinder chambers, so that the pressure of the pressure medium in the engagement direction on either piston generates at the same time a return force on the other piston, balancing the force in the engagement direction generated by the centrifugal force on the pressure medium.

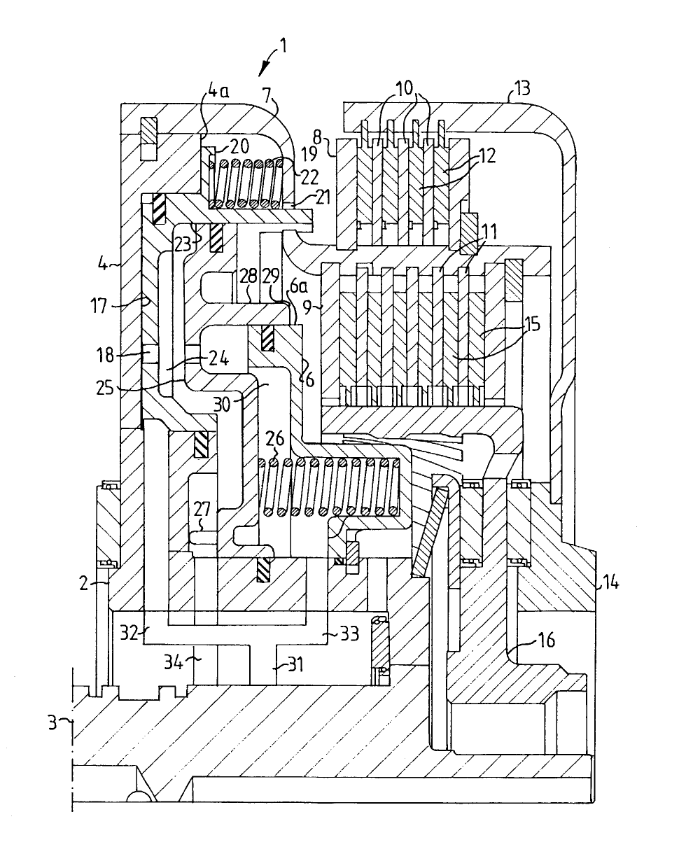

The present invention relates to a clutch arrangement, comprising an input clutch element intended to be drivably connected to an output shaft from a drive unit, a first output clutch element for driving a first input shaft to a transmission, a second output clutch element for driving a second input shaft to the transmission, said second input shaft being arranged concentrically to the first input shaft, a first clutch disc package having clutch discs joined alternatingly to the input clutch element and the first output clutch element, a second clutch disc package having clutch discs alternatingly joined to the input clutch element and the second output clutch element, and first and second piston-cylinder devices, respectively, coordinated with the first and second disc package, respectively, said piston-cylinder devices, upon supply of pressure medium to the respective cylinder chambers, are arranged to compress associated disc packages and establish driving connection between the input clutch element and the respective output clutch element.

Clutch arrangements of this type are used in vehicle gearboxes of the so-called power shift type, i.e. gearboxes with input shafts, which are each coupled to an individual clutch unit in a double clutch. In such gearboxes, the gear speeds can be preselected. Shifting is effected by disengaging one clutch and engaging the other clutch. In a gearbox known by SE 8700583-1, the double clutch consists of two axially separated clutch units having essentially the same construction; i.e. they each have an individual piston-cylinder device with a cylinder chamber defined between the associated piston and a wall of the clutch housing. A disadvantage of a double clutch of this type is that it requires a large amount of space in the longitudinal direction of the gearbox. Another disadvantage is that the centrifugal force acting on the hydraulic fluid as the clutch rotates, acting on the pistons in their engagement direction, requires heavy return springs for disengagement. Extra channels are required for lubricant as well.

The purpose of the present invention is in general to achieve a clutch of the type described by way of introduction, which has a simple and compact construction. A particular purpose is to achieve a clutch which is short in the axial direction and in which the effect of the centrifugal force on the hydraulic fluid can be balanced, so that disengagement can be effected with relatively small return springs.

This is achieved according to the invention by the fact that the cylinder chamber of the first piston-cylinder device is delimited between its piston and a first wall of the input clutch element, that the cylinder chamber of the second piston-cylinder device is delimited between its piston and the piston of the first piston-cylinder device, that a third cylinder chamber is delimited between the piston of the second piston-cylinder device and a second wall of the input clutch element, and that channels for supply of pressure medium to the cylinder chambers are arranged so that there is operating pressure simultaneously in the first and third cylinder chambers.

The invention integrates the piston-cylinder function, which makes it possible to arrange the clutch disc package concentrically so as to obtain an optimally short double clutch. Also, according to the arrangement, the pressure of the pressure medium on one piston in the engagement direction acts at the same time as a return force on the other piston, balancing the force in the engagement direction created by the centrifugal force on the pressure medium.

The invention is described below in more detail with reference to examples shown in the accompanying drawing, where the FIGURE shows a longitudinal section through one embodiment of a clutch according to the invention.

The clutch shown in the drawing has a clutch housing, generally designated 1, comprising a housing body 2, which is joined to a tubular element 3 intended to be drivably connected to a driving element, for example an output shaft from a torque converter (not shown). The housing body 2 has a first end wall 4 with a cylindrical flange 4a and a second end wall 6 with a cylindrical flange 6a. The housing 1 also includes a cover 7, which is solidly joined to the end wall 4 and non-rotatably but displaceably carries first and second pressure plates 8 and 9, respectively, and first and second sets of clutch discs 10 and 11, respectively. The discs 10 are included in a disc package, which also includes discs 12, which are non-rotatably but displaceably connected to a cover 13 which is solidly joined to a hub 14, which is intended to be non-rotatably connected to a tube shaft (not shown), which can be a first input shaft in the so-called power shift gearbox. The discs 11 are included in a disc package which also includes discs 15, which are non-rotatably but displaceably joined to a hub 16, which is intended to be joined to a second shaft (not shown) concentric to the first shaft.

The end wall 4 and the flange 4a form a hydraulic cylinder with a cylinder chamber 17, in which a first hydraulic piston 18 is displaceably housed. The piston 18 is biased towards the position shown in the drawing by peripherally evenly spaced helical springs 19, which are tensioned between the inside of the cover 7 and a radial flange 20 on the piston 18. Radially inside the springs 19, the piston 18 is provided with axially directed, peripherally evenly spaced fingers 21, which project through openings 22 in the cover 7. When hydraulic fluid under pressure is supplied to the cylinder chamber 17, the piston 18 will be displaced to the right in the FIGURE, and the fingers 21 will come into contact with the pressure plate 8 and compress the disc package 10,12, so that a driving connection is established between the clutch housing 1 and the hub 14.

The piston 18 is provided with a cylindrical flange 23, which together with the remaining portion of the piston forms a hydraulic cylinder with a cylinder room 24, in which a second hydraulic piston 25 is displaceably housed. The piston 25 is biased towards the position shown in the drawing by peripherally evenly spaced helical springs 26, which are tensioned between the inside of the second end wall 6 and the piston. Peripherally evenly spaced heels 27 determine the end position of the piston 25 in the disengagement direction. The piston 25 is also provided with a cylindrical flange 28. When hydraulic fluid under pressure is supplied to the cylinder chamber 24 and the piston 25 is displaced to the right in the FIGURE, the end surface 29 of the cylindrical flange 28 will come into contact with the pressure plate 9 and compress the disc package 11,15, thereby establishing a drive connection between the clutch housing 1 and the hub 16.

The flange 28 of the second piston 25 defines, together with the remaining portion of this piston and the second end wall 6 and its flange 6a, a third cylinder chamber 30. As is schematically illustrated with the channels 31, 32 and 33, hydraulic fluid is supplied under pressure also to the third cylinder chamber 30 when hydraulic fluid is supplied to the first cylinder chamber 17, when a driving connection is to be established between the clutch housing 1 and the hub 14. This means that both the force acting on the second piston 25 created by the oil pressure in the third cylinder chamber 30 and the force from the return springs 26 counteract the force acting in the engaging direction caused by the centrifugal force on the fluid in the second cylinder chamber 24. This means in turn that the return springs 26 can be less heavy than if the springs, as in previously known clutches of the type in question, had to overcome the centrifugal force on their own.

When a drive connection is to be established between the clutch housing 1 and the second hub 16, the first and third cylinder chamber 17 and 30, respectively, are drained via the channels 31, 32 and 33, and the second cylinder chamber 24 is supplied with hydraulic fluid under pressure via a channel 34. At the same time as the oil pressure in the cylinder chamber 24 presses the second piston 25 to the right in the FIGURE to compress the disc package 11,15, the reactive force created by the oil pressure together with the return springs 19 presses the first piston 18 to the left to the end position shown in the drawing. This means that the clutch formed of the disc package 10,12 will be released at the same time as the second clutch formed of the disc package 11,15 will be engaged. As is the case with the return springs 26, the return springs 19 of the first clutch can be dimensioned less strong than what would otherwise be required without the assistance of the return force on the first piston 18 created by the oil pressure. The axial extents of the fingers 21 and the heels 27 are selected so that the fingers can reach the pressure plate 8 and compress the disc package 10,12 to complete engagement without being impeded by the second piston 25 when it is in its left hand end position shown in the drawing.

By the described integration of the piston-cylinder functions, the disc package can be arranged concentrically, as shown in the FIGURE, so that an optimally short double clutch is obtained.

1. Clutch arrangement, comprising an input clutch element (1) intended to be drivably connected to an output shaft from a drive unit, a first output clutch element (14) for driving a first input shaft to a transmission, a second output clutch element (16) for driving a second input shaft to the transmission, said second input shaft being arranged concentrically to the first input shaft, a first clutch disc package having clutch discs (10,12) joined alternatingly to the input clutch element and the first output clutch element, a second clutch disc package having clutch discs (11,15) alternatingly joined to the input clutch element and the second output clutch element, and first and second piston-cylinder devices, respectively, (18,17 and 25, 24, respectively), coordinated with the first and second disc package, respectively, said piston-cylinder devices, upon supply of pressure medium to the respective cylinder chambers, are arranged to compress associated disc packages and establish driving connection between the input clutch element and the respective output clutch element, characterized in that the cylinder chamber (17) of the first piston-cylinder device is delimited between its piston (18) and a first wall (4) of the input clutch element (1), that the cylinder chamber (24) of the second piston-cylinder device is delimited between its piston (25) and the piston (18) of the first piston-cylinder device, that a third cylinder chamber (30) is delimited between the piston (25) of the second piston-cylinder device and a second wall (6) of the input clutch element, and that channels (31-33) for supply of pressure medium to the cylinder chambers are arranged so that there is operating pressure simultaneously in the first and third cylinder chambers.

2. Clutch arrangement according to claim 1, characterized in that the input clutch element (1) forms a cylinder (4a), which houses the piston (18) of the first piston-cylinder device, said piston (18) forming in turn a cylinder (23), which houses the piston (25) of the second piston-cylinder device, said piston (25) in turn forming a cylinder (28) housing a cylindrical flange (6a) on said second wall (6) of the input clutch element.

3. Clutch arrangement according to claim 1 or 2, characterized in that first and second return springs (19, 26) load the pistons (18, 25) of the piston-cylinder devices in the disengagement direction.

4. Clutch arrangement according to claim 3, characterized in that the return springs (19, 26) are evenly spaced helical springs and that the return springs (19) of the first piston-cylinder device are arranged radially outside the return springs (26) of the second piston-cylinder device.

5. Clutch arrangement according to one of claims 1-4, characterized in that the clutch disc packages (10,12 and 11,15, respectively) are arranged concentrically, with the first disposed radially outside the second.

6. Clutch arrangement according to one of claims 1-5, characterized in that the first clutch element forms a clutch housing (1) and that the piston (18) of the first piston-cylinder device is made with peripherally evenly spaced, axially directed fingers (21), which extend through openings (22) in the clutch housing and, upon supply of pressure medium to the cylinder chamber (17) and subsequent displacement of the piston, press against a pressure plate (8) of the first clutch disc package to establish driving connection between the clutch housing (1) and the first output clutch element (14).

7. Clutch arrangement according to one of claims 1-6, characterized in that said cylinder (28) of the piston (25) of the second piston-cylinder device has an end surface (29) which, upon supply of pressure medium to the cylinder chamber (24) between the pistons and subsequent displacement of the piston of the second piston-cylinder device in a direction towards the second clutch disc package, presses against a pressure plate (9) of said package to establish driving connection between the clutch housing (1) and the second output clutch element (16).
